(19) United States
(12) Patent Application Publication
(10) Pub. No.: US 2016/0008896 A1
(43) Pub. Date: Jan. 14, 2016

(54) CUTTER

(71) Applicant: Erron CRIDDLE, Malaga, Western Australia (AU)

(72) Inventor: Erron CRIDDLE, Malaga (AU)

(21) Appl. No.: 14/770,389

(22) PCT Filed: Feb. 25, 2014
(86) PCT No.: PCT/IB2014/000199

§ 371 Date: Aug. 25, 2015

(30) Foreign Application Priority Data
Feb. 25, 2013 (AU) 2013900627

(51) Int. Cl. B23D 45/02; B23D 45/14

(52) U.S. Cl. CPC B23D 45/024; B23D 45/14; B23D 45/028

(57) ABSTRACT

A cutter capable of cutting multiple intersecting faces in an elongate workpiece at precisely controlled angles or two faces at precise offsets in an elongate workpiece that can be pivoted about its longitudinal axis. The cutter being able to accurately make two or more intersecting or spaced apart cuts in the workpiece by adjusting the orientation of a workpiece holding means with respect to a cutting means in an x direction and at least two other directions chosen from a set including: y, z, α, β and γ, where the x, y and z directions are orthogonal Euclidean directions and the α, β and γ directions are polar angular directions. The workpiece is pivotable about a longitudinal axis that is contained within its cross sectional area, rather than being pivotable about a longitudinal axis disposed upon the outer surface or outside of the workpiece.

### CROSS-REFERENCE TO RELATED APPLICATIONS

This application is a U.S. National Phase of PCT/IB2014/000199 filed Feb. 25, 2014 which, in turn, claims priority to AU 2013900627 filed Feb. 25, 2013, the disclosures of which are hereby incorporated in their entirety by reference herein.

### FIELD OF THE INVENTION

The present invention relates to a cutter capable of cutting multiple intersecting faces in an elongate workpiece at precisely controlled angles or two faces at precise offsets in an elongate workpiece that can be pivoted about its longitudinal axis. In one form the invention relates to a dihedral cutter, and in another form the present invention relates to a multihedral cutter. In yet another form the invention relates to a single cutter moveable to make cuts spaced apart along an elongate workpiece, the cuts being in precise orientation to each other.

The purpose of the cutter of the present invention is to accurately make two or more cuts in an elongate member, such as for making frames, especially complex frames with multiples members meeting at irregular angles, for example, joins for roofing timbers and other construction members. Also, for making one or more cuts at opposite ends very accurately, especially for a workpiece that has a round cross-section, although suitable for use with other cross-section workpieces, including irregular shapes.

### TERMINOLOGY

So as to avoid confusion the following specific terminology is used in the context of the present invention:
the term “dihedral” means an angle formed between two intersecting surfaces;
the term “multihedral” is used to describe two or more surfaces that intersect at an angle to each other.
the term “workpiece” refers to an object to be worked on by the cutter, the workpiece may be hollow or solid, is typically elongate with a constant cross-section, and may be of irregular cross-sectional shape, such as, for example, a right angle.
the term “mitre saw” is used to refer to a device that guides a cutting device with respect to a workpiece to be cut. In some countries this is spelt “miter saw”.
the term “spaced apart cuts” refers to two or more cuts made along the length of a workpiece, where precise orientation between the cuts is required.

The present invention shall be generally referred to in the context of a multihedral cutter since that is the more complex implementation of the teaching of this art in providing two or more intersecting or spaced apart cuts in an elongate workpiece.

### BACKGROUND TO THE INVENTION

It is known to use a hand held cutting device (rotary or otherwise, such as a rotary disk electric saw or a hand saw) to cut a workpiece to a desired length and at a desired angle. The accuracy of such a cut generally depends upon the skill of the operator of the cutting device.

The accuracy of the cut in a workpiece can be improved by using a mitre box within which the workpiece may be held and the cut made with a hand saw. This still results in inaccuracy due to the width of a cut slot in the mitre box and how steadily the workpiece can be held in the mitre box (or miter box). Where a hand held saw is used with the mitre box, the accuracy of the cut still depends largely upon the skill of the operator.

A slightly more accurate cut can be made using a precision mitre box in which the cutting saw is gripped in a slideable frame positioned across the workpiece. However, this type of mitre box is limited as to the shape of the workpiece that it can hold and making multiple intersecting (so called “multihedral cuts”) or spaced apart cuts again relies generally upon the skill of the operator.

A still more accurate cut can be made using a drop/mitre saw, which is a circular electrically operated saw head whose orientation is adjustable over a mitre bench or table (often referred to as a “crosscut compound mitre saw”, although more commonly referred to as a “compound mitre saw”). However, even with a drop/mitre saw, a cut accuracy of less than 1 mm is still difficult to achieve, especially when multihedral cuts are made, and spaced apart cuts are even less accurate. The issue with a drop/mitre saw is that it has a fixed fence through which the cuts must be made. The provision of the fence places limitations upon the way in which the cuts can be made. Perhaps the most advanced attempt at this is in U.S. Pat. No. 6,212,983, directed to a tiltable infeed and outfeed saw table which is pivotable about its horizontal longitudinal axis, designed for computer automation of cutting composite angles in rectangular cross-section roofing rafters. Even in this device there is no way to accurately pivot the workpiece about an axis internal of its cross-sectional area, instead the pivoting achievable by '983 is only about a nip of the fence and the saw table. Also, this type of fence based cutter requires a gap through which a saw blade can pass to make a cut in the workpiece and is not suitable for making accurate partial cuts in the workpiece or spaced apart cuts. Further, this is a large and expensive automated mitre table and is not readily portable.

Each of the above cutting devices is not well suited to making dihedral or multihedral cuts in an elongate workpiece. As an example, cutting a round elongated workpiece with multiple intersecting or spaced apart cuts requires the cuts to be aligned accurately and is almost impossible to be done accurately with prior art systems as the only option is to clamp down the workpiece or hold it by hand every time the workpiece needs to be rotated. In some prior art systems the accuracy of the cut angle has been increased by using lasers and highly stable cutting device holders/pivots, however only minor innovation has been applied to the fence. The standard “fence” is still used and requires that the workpiece be either clamped or held by hand against the fence. The fence was first introduced as a piece of angle bar in 1924 (ref U.S. Pat. No. 1,569,186).

The cutter of the present invention overcomes most of these limitations of cut accuracy by setting a precise rotational radial orientation of the workpiece, especially when making more than one cut and without the need for a fence (however a fence may be used).

### SUMMARY OF THE INVENTION

Therefore, it is an object of the present invention to provide a cutter capable of precisely controlling the making of two or more cuts in a workpiece which can be pivoted about its longitudinal axis.

In accordance with one aspect of the present invention, there is provided a cutter for making at least one cut in an elongate workpiece, the cutter including:

a base means;

a reference axis orthogonal to the base means, the reference axis being the locus of a plurality of fixed reference points;

a cutting means pivotably mounted upon the base means about a pivot axis, the cutting means having a cutting element moveable in a cutting plane to intersect the reference axis, the orientation of the cutting element with respect to the reference axis being adjustable and settable, and the reference axis being parallel to the pivot axis;

a workpiece holding means mounted upon the base means and moveable with respect to the reference axis, the workpiece holding means releasably retaining the workpiece for securing the workpiece with respect to the base means;

wherein the workpiece holding means adjusts the orientation of the workpiece with respect to the reference axis such that a longitudinal axis within the cross-section of the elongate workpiece can intersect one of the fixed reference points on the reference axis; and

wherein the workpiece holding means can pivot the workpiece about its longitudinal axis for making a plurality of cuts in the workpiece whilst the workpiece is clamped in the workpiece holding means; and

wherein the one of the fixed reference points is the intersection of the reference axis and the cutting plane; and

wherein the orientation of the cutting plane with respect to the fixed reference point is adjustable for making cuts in the workpiece, the cuts being at least one from a group of cut types including a plurality of intersecting cuts and a plurality of spaced apart cuts; and

wherein the orientation of the cuts relative to each other is adjustable.

In accordance with another aspect of the present invention, there is provided a cutter for making at least one cut in an elongate workpiece, the cutter including:

a base means;

a reference axis orthogonal to the base means, the reference axis being the locus of a plurality of fixed reference points;

a cutting means pivotably mounted upon the base means about a pivot axis, the cutting means having a cutting element moveable in a cutting plane to intersect the reference axis, the orientation of the cutting element with respect to the reference axis being adjustable and settable, and the reference axis being parallel to the pivot axis;

a workpiece holding means mounted upon the base means and moveable with respect to the reference axis, the workpiece holding means releasably retaining the workpiece for securing the workpiece with respect to the base means;

wherein the workpiece holding means adjusts the orientation of the workpiece with respect to the reference axis such that a longitudinal axis within the cross-section of the elongate workpiece can intersect one of the fixed reference points on the reference axis; and

wherein the workpiece holding means can pivot the workpiece about its longitudinal axis for making a plurality of cuts in the workpiece whilst the workpiece is clamped in the workpiece holding means; and

wherein the one of the fixed reference points is the intersection of the reference axis and the cutting plane; and

wherein the orientation of the workpiece holding means and the cutting means with respect to the fixed reference point is adjustable in an x direction and at least two other directions chosen from a set including: y, z, α, β and γ, where the x, y and z directions are orthogonal Euclidean directions and the α, β and γ directions are polar angular directions; and

wherein the orientation of the cutting plane with respect to the fixed reference point is adjustable for making cuts in the workpiece, the cuts being at least one from a group of cut types including a plurality of intersecting cuts and a plurality of spaced apart cuts; and

wherein the orientation of the cuts relative to each other is adjustable.

Typically, the Euclidean directions and/or the polar directions can be associated with any one or more of the workpiece holding means and the cutting means. That is, the movement of the workpiece with respect to the fixed reference point can be attributed to movement of any one or more of the workpiece holding means and the cutting means, either individually or in concert.

Typically the workpiece has a uniform and constant cross-section.

Typically, the workpiece holding means may be in the form of a fence or a chuck (which the workpiece can pass completely through) or any means able to conform to or be releasably secured to the cross-sectional area of the workpiece. The workpiece holding means typically includes a clamp means for releasably securing the workpiece.

Typically, the workpiece holding means is disposable and lockable for adjusting the transverse orientation of the workpiece with respect to the longitudinal axis of the workpiece and the pivotal orientation of the workpiece with respect to the longitudinal axis of the workpiece.

Typically, any longitudinal axis interior of the workpiece can be disposed to intersect with the fixed reference point.

Typically, the cutter of the present invention also has a guide means for controlling the longitudinal orientation of the workpiece in the workpiece holding means so that multiple workpieces can be cut consecutively at the same position along the length of the workpiece.

Conveniently, a slide means is provided upon the base means, the slide means being displaced from the reference axis, and moveable with respect to the reference axis, the slide means supporting the rest of the workpiece holding means for adjusting the orientation of the workpiece with respect to the fixed reference point.

Typically, the cutting element is in the form of a drop saw or cold cut saw or an angle grinder of conventional type, each with a circular cutting blade spun upon a shaft.

Alternatively, the cutting element could be in the form of a hand saw or the like.

The reference axis may be the axis of pivot of the cutting means upon the base means, although this is not essential.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following description of a specific embodiment of the present invention, given by way of example only, with reference to the accompanying drawings in which:

FIG. 1 is a perspective view, seen from above, of a multihedral cutter in accordance with one embodiment of the present invention, including a cutting means in the form of an angle grinder;

FIG. 2 is a perspective view, seen from above and to an enlarged scale, of part of the multihedral cutter of FIG. 1, shown with the angle grinder removed and with a slide block of a workpiece holder ghosted for clarity;

FIG. 3 is a plan view of the multihedral cutter of FIG. 2, with the cutting blade of the angle grinder shown disembodied from the angle grinder;

FIG. 4 is a perspective view, seen from above, of a multihedral cutter in accordance with another embodiment of the present invention, including computerised control.

### DETAILED DESCRIPTION OF PREFERRED EMBODIMENTS

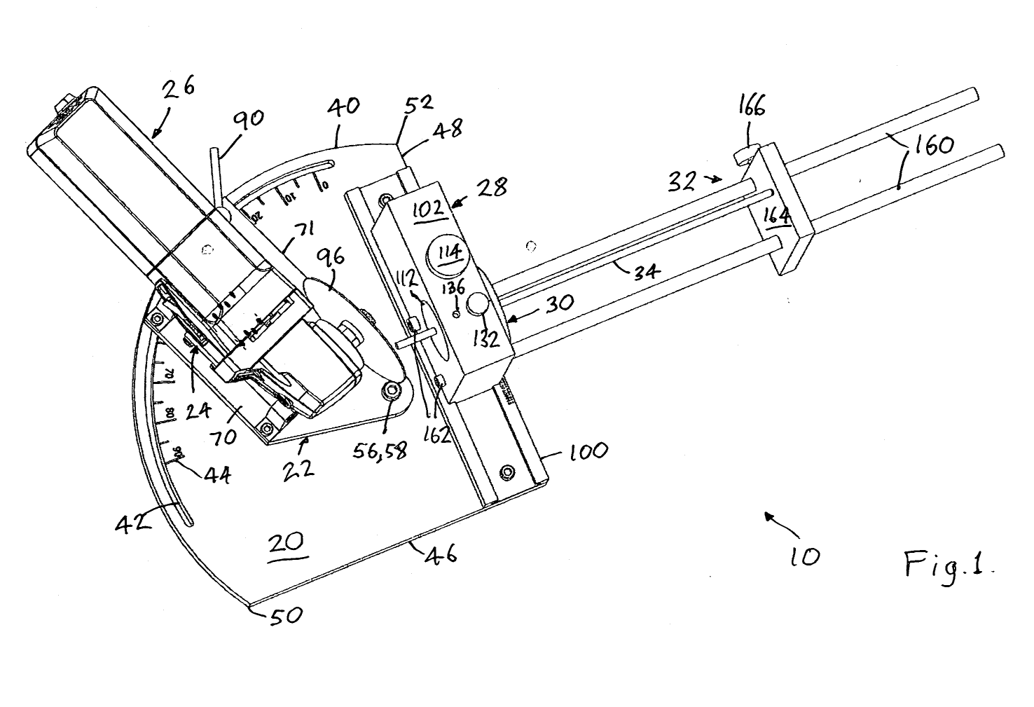

In FIG. 1 there is shown a multihedral cutter 10 in accordance with one embodiment of the present invention. The multihedral cutter 10 generally comprises a base means, a reference axis orthogonal to the base means, a cutting means pivotably mounted upon the base means and a workpiece holding means for releasably retaining a workpiece.

More particularly the multihedral cutter 10 comprises a base means in the form of a base element 20, a swivel element 22, a reciprocation element 24, a cutting device 26 (these elements 22, 24 and 26 comprising the cutting means), a slide element 28, a workpiece holder 30 and an extension guide 32 (these elements 28, 30 and 32 comprising the workpiece holding means), all of which cooperate to make precise cuts to a workpiece 34 held in the workpiece holder 30.

The multihedral cutter 10 is typically made of metals materials, such as, for example, mild steel, although it could be made from engineering grade plastics materials, such as, for example, carbon or metal fibre reinforced nylon, or a combination of these and other materials.

The base element 20 is generally planar with an arcuate edge 40 adjacent which is a slot 42 along which are graduations 44 indicative of the angle of orientation of the swivel element 22 with respect to the base element 20. Typically, the graduations extend from 0 degrees to 90 degrees of arc.

Conveniently the base element 20 is generally rectangular in plan with two orthogonal sides 46 and 48 and the arcuate edge 40 subtending distal corners 50 and 52 of the respective sides 46 and 48. The slot 42 is disposed substantially between the corners 50 and 52 and at a constant distance from a pivot hole 56 located generally intermediate the bounds of the base element 20. Within the pivot hole 56 is a pivot bolt 58 which connects the swivel element 22 to the base element 20 and permits pivoting therebetween.

The pivot hole 56 and the pivot bold 58 together define a pivot axis about which the swivel element 22 pivots upon the base element 20. For convenience the pivot axis bears the number 58.

The multihedral cutter 10 also has a reference axis which is the locus of a plurality of fixed reference points. The reference axis is the focus on the cutting device 26 and either coincides with the pivot axis or is parallel to the pivot axis. The reference axis can be the locus of an infinite number of fixed reference points.

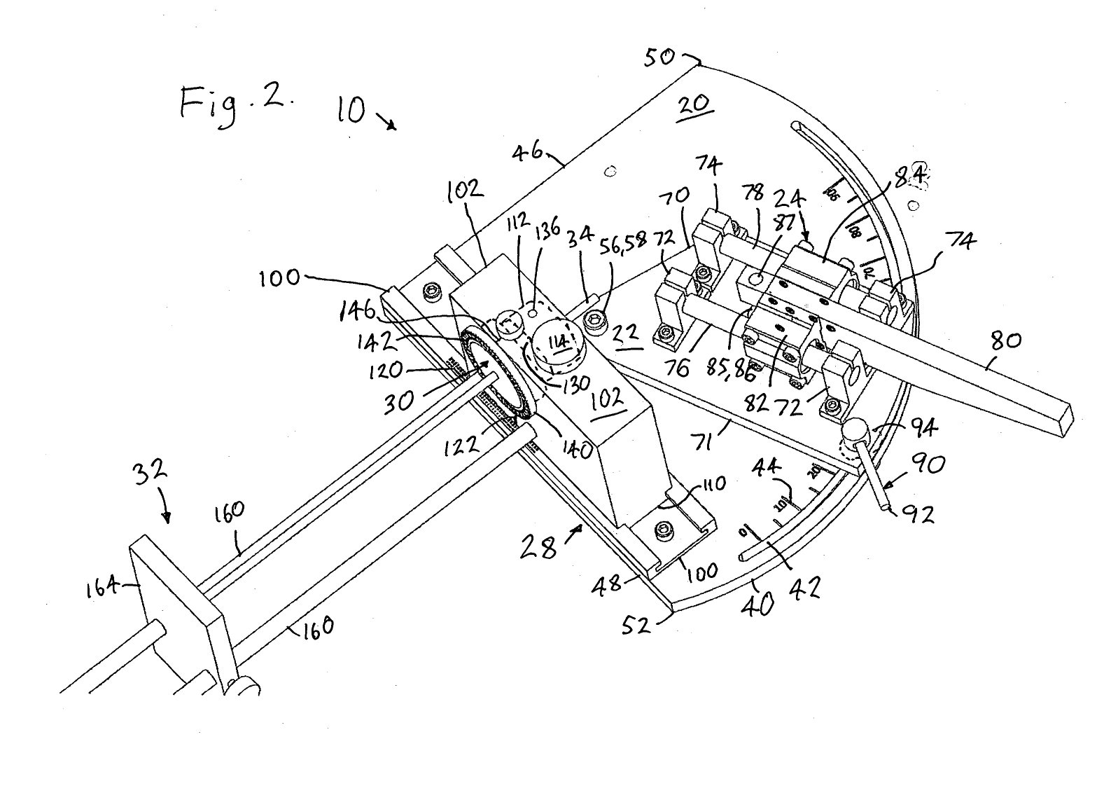

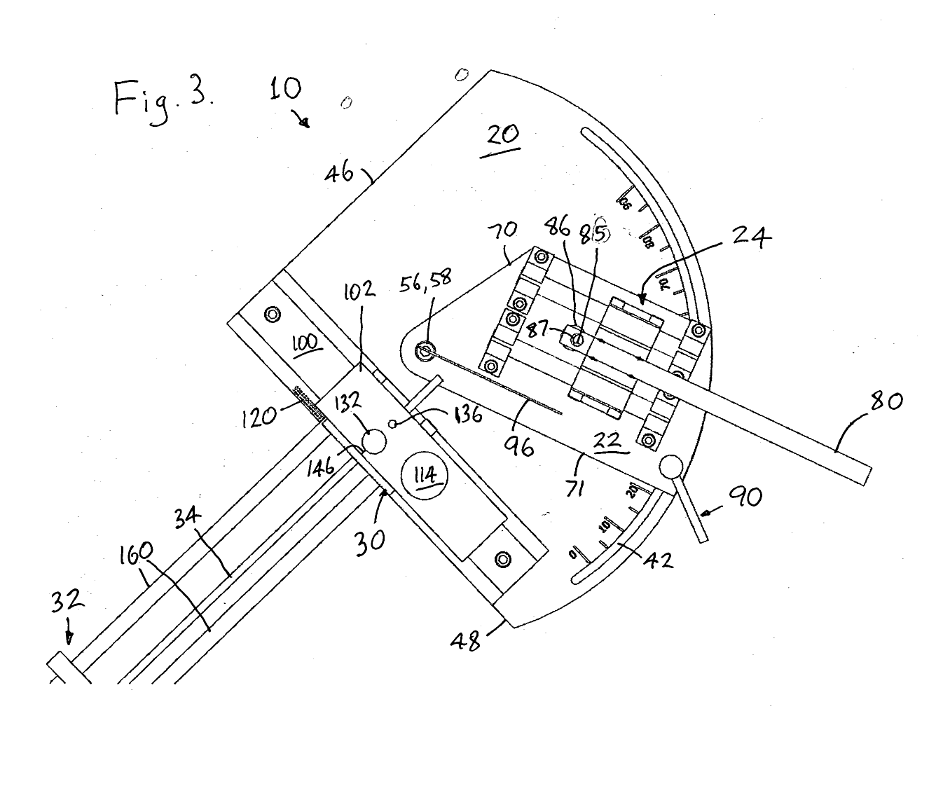

The swivel element 22, particularly as shown in FIGS. 2 and 3, comprises a platen 70 with a leading edge 71. The swivel element 22 can be pivoted about the bolt 58 so that when the leading edge 71 rests upon the “0” graduation of the slot 42 the leading edge 71 is substantially parallel to the side 48 of the base 20 and the slide element 28; and when the leading edge 71 aligns with the “90” graduation of the slot 42 the leading edge 71 is substantially parallel to the axis of the workpiece 34 and may also be aligned coaxially with the workpiece 34. The disposition of the swivel element 22 with respect to the base element 20 may be a number of discrete jumps in angle, such as for example, every degree or half degree of angle between 0 and 90 degrees.

The reciprocating element 24 has two pairs of stands 72 and 74 and two slide bars 76 and 78. The stands 72 and 74 are disposed orthogonally to the surface of the platen 70. The stands 72 are spaced apart on the platen 70 and interconnected by the slide bar 76. Typically, the slide bar 76 is cylindrical in shape. The stands 74 are similarly disposed and interconnected by the slide bar 78. The slide bars 76 and 78 are substantially parallel to each other and substantially parallel to the leading edge 71. Preferably the slide bars 76 and 78 are precisely parallel to the leading edge 71 for precise orientation of the cutting element 24 with respect to the workpiece 34.

The reciprocating element 24 also has a support frame 80 disposed between and journalled upon the slide bars 76 and 78 respectively by slide bearings 82 and 84 for reciprocating motion of the cutting element 24 with respect to the workpiece 34.

In the present embodiment the cutter device is in the form of an angle grinder. The angle grinder 26 is attached onto the support frame 80 such as by a bolt (not shown) which passes through a hole 85 in the base 20, when it overlies a hold 86 in the platen 70 and through a hole 87 in the support frame 80. The left hand side of a blade of the angle grinder 26 can be adjusted (not shown) so that it passes directly over the centre of the pivot bolt 58 so that when the angle grinder 26 is swiveled around the pivot bolt 58, an accurate length/angle is cut. If the workpiece wastage is to be to the left hand side of the cut, then the adjustment would be made so that the right hand side of the blade passes directly over the centre of the pivot bolt 58.

It is envisaged that the support frame 80 could be shaped to provide a surface to accurately conform to the shape of one side of the angle grinder 26 to provide a more robust mounting for the angle grinder 26 upon the swivel element 22.

The swivel element 22 typically also has a locking element 90 which has a bolt (not shown), extending through the platen 70 and the slot 42 in the base element 20, a bar 92 depending from the bolt, and a nut 94 located on the underside of the slot 42. Pivoting of the bar 92 can tighten the bolt into the nut to lock the swivel element 22 with respect to the base element 20. In the exemplary embodiment as shown in the drawings the swivel element 22 is locked at an angle of 18 degrees with respect to the side 48 of the base element 20. In the present embodiment the angle of the swivel element 22 can be adjusted to any angle between 0 and 90 degrees.

The angle grinder 26 is conveniently of conventional type and has a cutting blade 96 (also referred to herein as the cutting element) disposed parallel to the leading edge 71 of the swivel element 22. The cutting blade 96 defines a cutting plane that intersects with and is focussed upon a fixed reference point of a reference axis. The angle grinder 26 can be reciprocated back and forth across the longitudinal axis of the workpiece 34, over the fixed reference axis, by the reciprocation element 24.

The slide element 28 comprises a slide 100, a slide block 102 and a workpiece holder 30. The slide 100 is conveniently an extrusion with a C-shaped cross-section (especially as shown in FIG. 2), fixed adjacent the side 48 of the base element 20. The slide block 102 has a slide edge 110 shaped to mate with the slide 100 to permit sliding movement of the slide block 102 along the length of the slide 100. The slide block 102 is conveniently shaped as a rectangular prism and has a port 112 extending through it perpendicular to the side 48 within which is received the workpiece holder 30.

The slide block 102 also has a locking screw 114 disposed through it in a threaded hole for engaging with the slide 100 to lock the slide block 102 to the slide 100 to prevent movement of the slide block 102 with respect to the slide 100 during cutting operations.

The slide 100 is provided with graduations 120 and the slide block 102 has a reference notch, conveniently in the form of a mark 122, disposed to indicate the position of the slide block 102 with respect to the slide 100. The graduations 120 are length measurements typically arranged in millimetre spacings with a zero reference mark intermediate its length corresponding with the axis of the pivot bolt 58 (pivot axis) and increasing in measure in each direction leading away from the zero mark, conveniently a distance of around 40 mm (for a typical handheld angle grinder, and larger for larger cutting devices 26). In the exemplary embodiment the slide block 102 has been moved along the slide 100 so the mark 122 corresponds to the 19 mm graduation 120.

The workpiece holder 30 is generally cylindrical in shape at its external extent for rotation within the port 112 in the slide block 102. The workpiece holder 30 has an annular groove 130 within which is received an end of a workpiece screw 132 to ensure the workpiece holder 30 does not move longitudinally in the port 112 and so remains within the slide block 102. Conveniently the workpiece holder 30 has an internal extent shaped to conform to the external cross-section of the workpiece 34. In this embodiment the workpiece holder 30 is specific to the cross-sectional shape of the workpiece 34 and so a difference workpiece holder 30 is needed for each different cross-section workpiece 34.

The slide block 102 also has a hole 136 which extends into the port 112 for tightening of a grub screw, located in the workpiece holder 30. The grub screw extends to the centre of the workpiece holder 30 so as to secure the workpiece into the workpiece holder 30. A grub screw is required so as to permit the workpiece holder 30 to be able to rotate in the slide block 102 once the workpiece 34 is secured into the workpiece holder 30.

The workpiece holder 30 has a dial face 140 disposed on one side of the slide block 102, conveniently opposite the angle grinder 26. The dial face 140 has graduations 142 measured in degrees of arc from 0 to 360 degrees. The dial face 140 can be manipulated to change the radial angle of the workpiece 34 with respect to the cutting blade 96. The angle of the workpiece holder 30 can be temporarily fixed by screwing the workpiece screw 132 into the groove 130.

The slide block 102 has a mark 146 located adjacent the dial face 140 for accurately measuring the angle of orientation of the workpiece 34 with respect to the cutting blade 96.

In the accompanying drawings the workpiece holder 30 has a central aperture 150 dimensioned to conform to the shape of the workpiece 34.

Alternatively the workpiece holder 30 could have a plurality of jaws (such as, for example, a lathe type chuck that the workpiece 34 can pass completely through) or an angled holder (not shown) whose position is adjustable to hold the workpiece 34 about a central axis of the workpiece holder 30. This allows differing cross-section workpieces 34 to be readily held within the workpiece holder 30 and permits one workpiece holder 30 to be used with workpieces 34 of differing cross-sections.

The slide block 102 also has two holes parallel to the axis of the workpiece holder 30 for retaining the extension guide 32.

The extension guide 32 conveniently has two rods 160 fixed by bolts 162 into the slide block 102. The rods 160 carry an extension slide 164 which is slideable therealong. The extension slide 164 has a locking screw 166 for releasably setting the position of the extension slide 164 along the rods 160 for providing an end stop for the workpiece 34 so that multiple workpieces can be reliably cut to the same length. The rods 160 may also contain graduations to be aligned with the extension slide 164 so that more accurate cuts can be made in the workpiece 34 when the extension guide 32 is used.

The intersection of the cutting plane with the pivot axis 56, 58 and the longitudinal axis of the workpiece 34 defines a free point in space (the so called fixed reference point) which is one of the plurality of fixed reference points of the present invention.

The direction of the longitudinal axis of the workpiece 34 is referred to as the x direction, the direction of movement of the slide element 28 is the y direction and orthogonal to the plane of the base element 20 is the z direction. Pivoting of the workpiece 34 is movement in the α, direction polar angular direction, whilst pitch and yaw directions represent β and γ directions of movement.

The reference axis is orthogonal to the base and defines a plurality of fixed reference points that can intersect the longitudinal axis of the workpiece 34. The adjustment of the swivel element 22 between 0 and 90 degrees will intersect a single fixed reference point only. The infinite number of fixed reference points on the reference axis is defined by the transverse adjustment of the workpiece holding means in the Z direction. However, in this embodiment there is only a singular fixed reference point.

### Use

In use, the base element 20 is set upon a surface such as a work bench, the angle grinder 26 is attached to the reciprocation element 24 with the bolt through the holes 85 to 87. A workpiece holder 30 is chosen to confirm closely to the external shape of the workpiece 34. The workpiece 34 is inserted into the workpiece holder 30 and the extension slide 166 locked into place with the locking screw 166 to set the desired cutting length of the workpiece 34 with respect to the cutting blade 96. The workpiece 34 is then secured into the workpiece holder 30 with the grub screw to temporarily prevent its longitudinal movement during the cutting process.

The transverse position of the workpiece 34 can be adjusted by sliding the slide block 102 along the slide 100 against the graduations 120. The rotational position of the workpiece 34 can then be adjusted by rotating the workpiece holder 30 against the graduations 142 and locked into angular position with the workpiece screw 132.

The angle of the cut that is to be made into the workpiece 34 is then set by adjusting the angle of the swivel element 22 against the graduations 44 along the slot 42 in the base element 20 and locking the swivel element 22 into position with the locking element 90.

Electrical power can then be applied to the angle grinder 26 to activate the cutting blade 96, and the angle grinder 26 slid along the reciprocation element 24 so that the cutting blade 96 can meet with and cut through the workpiece 34 intersecting its longitudinal axis at one of the fixed reference points.

The cutting blade 96 is disposed to be reciprocated by the reciprocation element 24 over the centre of the pivot hole 56 and pivot bolt 58. The pivot hole 56 and the pivot bolt 58 together constitute the pivot axis of the present invention which is typically the focal point of cuts made with the cutting blade 96—in which case the reference axis coincides with the pivot axis.

So as to achieve a cut accuracy that is better than (that is less than) the width of the cutting blade 96 one side of the cutting blade is aligned with the centre axis of the pivot bolt 58. The side of the cutting blade 96 that is so aligned depends upon which part of the workpiece 34 is waste. Typically the waste part of the workpiece 34 is the part that is situated above the base element 20 and distant from the workpiece holder 30, and the left hand side of the cutting blade 96 is aligned with the centre of the pivot axis. In the event that the waste part of the workpiece 34 is that which remains secured within the workpiece holder 30 after the cut has been made, the right hand face of the cutting blade is aligned with the centre of the pivot axis. The left hand side of the cutting blade 96 is that side which is closest to the workpiece holder 30.

After one cut has been made the workpiece screw 132 may be loosened, the workpiece holder 30 rotated a desired angle as measured by the dial face 140 against the mark 146. The workpiece screw 132 is then retightened and another cut made across the workpiece 34 intersecting with the first cut. Thereby dihedral and multihedral cuts can be accurately made in the workpiece 34.

By the use of the cutter 10 of the present invention the workpiece 34 can be moved with respect to the cutting element 96 in x, y, z, α, β and γ directions, where the x, y and z directions are orthogonal Euclidean directions and the α, β and γ directions are polar angular directions. Typically, the workpiece 34 is adjustable in at least three of these directions. More particularly, the workpiece 34 can be adjusted in two orthogonal Euclidean directions and one polar direction by the use of the workpiece holder 30 and a further adjustment is made by the pivotable orientation of the swivel element 22. Conveniently, in the present embodiment the x direction is along the centre axis of the workpiece 34 and the y direction is the direction of movement of the slide element 28.

In fact the three or more directions of orientation can be shared between the workpiece holding means and the cutting means. For example, any number of directions of orientation of the workpiece 34 with respect to the cutting blade 96 from nil to six could be associated with the workpiece holding means whilst a corresponding nil to six directions could be associated with the cutting means, with the total number of directions of adjustment of the orientation being up to twelve. In the present embodiment, adjustments are only possible in four directions, being x, y and α for the workpiece holding means and β for the cutting means.

### Other Variations

Another form of the invention omits the swivel element 22 and adds movement in a polar direction equivalent to that of the swivel element 22 to the workpiece holder 30. A limitation of this embodiment is that it is not well suited to long workpieces 34.

Another form of the invention may consist of two or more workpiece holders 30, slideable along a common track, to secure a workpiece 34 and a slideable swivel element 22 that can be slid parallel to the track for making longitudinally spaced apart cuts in the workpiece 34, and there being graduations common to the track and the swivel element 22 so that the workpiece 34 can be accurately cut at each end or at two or more locations along the length of the workpiece 34, wherein the orientation of the plurality of cuts are in precise arrangement with respect to each other.

Another form of the invention may consist of two or more slideable workpiece holders 30 to secure a workpiece 34, wherein the workpiece holders 30 and the workpiece 34 are together slideable along a common track perpendicular to the pivot axis 56, 58, where there are graduations common to the track and the pivot axis 56,58 so that a workpiece 34 can be accurately cut at two or more locations along the length of the workpiece 34.

Another form of the invention may consist of the swivel element 22 and cutting means being positioned behind the workpiece 34 and the workpiece holder/s 30 and used in a similar fashion to existing conventional drop/mitre saw.

Another form of the invention involves an arrangement, whereby the workpiece holder 30 can be moved to the other end of the workpiece 34 so that one end of the workpiece 34 can be aligned with the other end of the workpiece 34. Or the workpiece 34 temporarily be clamped for correct alignment of the workpiece 34. This form of the invention only applies to round bar as any other type of workpiece with a radial reference point will not have this issue.

Another form of the invention involves the pivoting of the slide block 102 and the contained workpiece holder 30 around the pivot bolt 58. This enables two way pivoting/rotation about the intersection of the pivot bolt 58 and the longitudinal axis of the workpiece 34 and the cutting blade 96.

Another form of the invention includes a standard fence that the workpiece is clamped to, whereby the table can be adjusted in an Y and Z position so that the longitudinal axis of the workpiece 34, represented as the X axis, intersects the pivot axis 56, 58 and the left or right hand side of the cutting blade 96 when passed through the pivot axis 56, 58. The table can also be angularly adjusted about the longitudinal axis of the workpiece 34. Typically, the fence is disposed along or adjacent the edge 46.

Another form of the invention includes a standard fence that the workpiece 34 is clamped to, whereby the table can be adjusted in an Y and Z position so that the longitudinal axis of the workpiece 34, represented as the X axis, intersects the centre of the pivot bolt 58 and the left or right hand side of the cutting blade 96 and the table is also slideable so that the workpiece 34 can be cut at either end. The table can also be angularly adjusted about the longitudinal axis of the workpiece 34.

Another form of the invention includes a standard fence that the workpiece 34 is clamped to, whereby the table can be adjusted in an Y and Z position so that the longitudinal axis of the workpiece 34, represented as the X axis, intersects the centre of the pivot bolt 58 and the left or right hand side of the cutting blade 96 and the swivel element 22 is slideable so that the workpiece 34 can be cut at either end. The table can also be angularly adjusted about the longitudinal axis of the workpiece 34.

In another form of the invention the workpiece holder 30 is used to hold a short length workpiece 34 and there is a longitudinal slide for the workpiece holder 30 and graduations for accurate longitudinal length measurement so that cuts can be made at either end of the workpiece 34. Also, there could be two workpiece holders 30 to support a very long workpiece 34 so the same cuts can be made.

Another embodiment of the workpiece holder 30 could be in the form of a “clam shell” type two piece clamp pivoted with an upper and a lower portion capable of conforming to the external cross-sectional shape of the workpiece 34. The upper and lower portions being releasably lockable together to secure the workpiece 34 with respect to the base element 20. Also, the clamp could have a separate means for conforming to the external cross-sectional shape of the workpiece 34, such as, for example, a profile cut to the precise shape of the workpiece 34—in which case each different workpiece 34 requires its own clamping profile.

### Another Embodiment

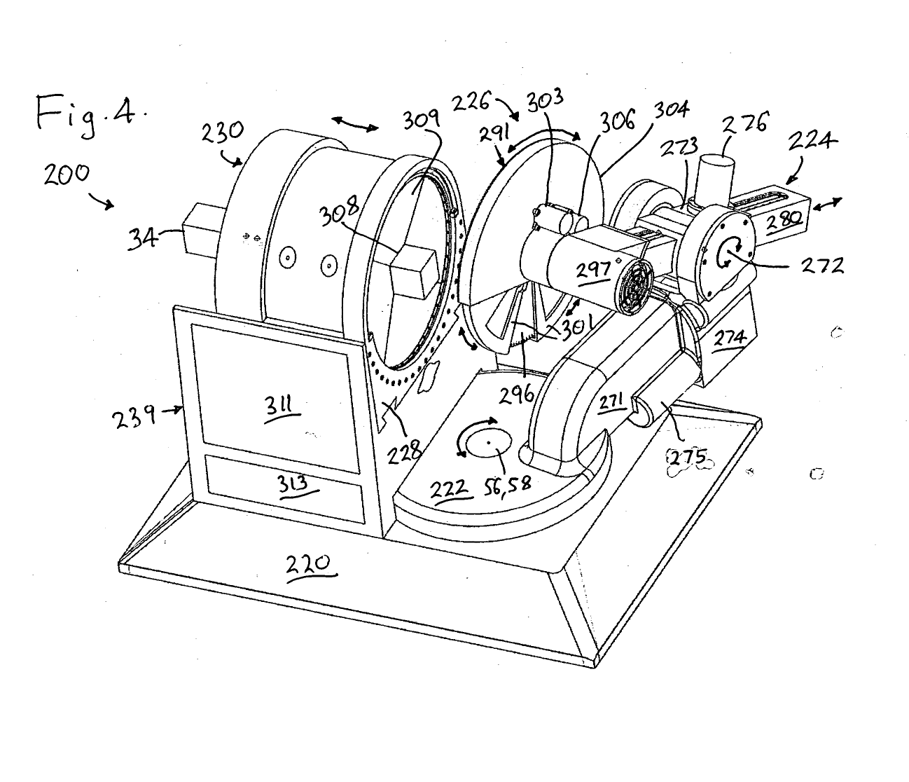

In FIG. 4 there is shown a multihedral cutter 200 in accordance with another embodiment of the present invention.

The multihedral cutter 200 is generally the same as the multihedral cutter 10 and like numerals denote like parts. The multihedral cutter 200 generally comprises a base means, a reference axis orthogonal to the base means, a cutting means pivotably mounted upon the base means and a workpiece holding means for releasably retaining a workpiece.

More particularly the multihedral cutter 200 comprises a base means in the form of a base element 220, a swivel element 222, a reciprocation element 224, a cutting device 226 (these elements 222, 224 and 226 comprising the cutting means), a slide element 228 and a workpiece holder 230 (these elements 228 and 230 comprising the workpiece holding means), all of which cooperate to make precise cuts in a workpiece 34 held in the workpiece holder 230.

The multihedral cutter 200 achieves adjustment of the orientation of the cut in the workpiece 34 with the swivel element 222, the cutting device 226, the slide element 228 and the workpiece holder 230, as does the multihedral cutter 10. The x, y, z, α, β and γ directions of adjustment can be shared between these four components.

The main difference between the multihedral cutters 10 and 200 is the linear direction of motion of the workpiece holding means. In the cutter 10 the workpiece holding means moves transverse to the longitudinal axis of the workpiece 34, whereas in the cutter 200 the workpiece holding means moves in the same direction as the longitudinal axis of the workpiece 34.

Further, the multihedral cutter 200 has a controller 239 configured for electronic control of the cut orientation, hence graduations and setting screws are not needed.

Still further, in the exemplary embodiment of the multihedral cutter 200, the cutting device 226 is a drop saw rather than the angle grinder 26 of the multihedral cutter 10. Hence, the multihedral cutter 200 is much larger than the multihedral cutter 10—yet is still portable.

More particularly, the base element 220 is generally rectangular and relatively thick so as to provide a support for the swivel element 222, the slide element 228 and the workpiece holder 230. Preferably, bearing surfaces are provided between the swivel element 222 and the base element 220 to provide for low friction motion therebetween to overcome jerky motion that may otherwise occur due to the mass of the swivel element 222 and the cutting device 226. More particularly, the bearing surfaces may include a ball bearing race centered upon the pivot axis 58.

The swivel element 222 has a platen 270 pivotably attached to the base element 220 about the pivot axis 58. The swivel element 222 also has an arm 271 extending tangentially with respect to the pivot axis 58. At the distal end of the arm 271 is a horizontal pivot member 272 that contains a reciprocation housing 273. The pivot member 272 contains two worm gears that are mounted in the reciprocation housing 273. These worm gears are driven by worm screws (not shown) contained within a housing 274, the reciprocation housing 273 pivots about the horizontal axis of the pivot member 272.

The worm screws are driven by a pinion (not shown) that is driven by a reciprocating stepper motor 275 (attached at the bottom of arm 271).

The reciprocation housing 273 receives a reciprocation element 224 that is driven by a slide arm motor 276 longitudinally with respect to the swivel element 222.

The slide arm motor 276 controls the longitudinal distance of the cutting blade and the reciprocating stepper motor 275 controls the pivot angle with respect to the pivot member 272 and work in concert to cut the workpiece 34.

The reciprocating element 224 includes an arm 280 which is mounted into the reciprocation housing 273 at one end and connected to the cutting device 226 at its other end. The arm 280 is drive by the slide arm motor 276 for moving the cutting device 226 into the workpiece 34.

The cutting device 226 has a cutting head 291 within which is rotatable mounted a cutting blade 296, driven by a motor 297. Protecting the cutting blade 296 are two guards 301 which are also driven by a stepper motor 303 which controls the degree of pivoting of the guards 301, away from each other, to be just enough to avoid fouling the workpiece 34 during the cutting process—thereby providing protection to users from accidental collision with the cutting blade 296 and thus avoiding injuries. A guard housing 304 is also driven by stepper motor 306 so that the two guards 301 can be opened the minimal distance necessary to permit plunging of the blade 296 into the workpiece 34.

It is preferred that the cutting device 226 be maintained in a vertical plane in all modes of cutting—since, it becomes relatively clumsy to operate a large circular saw blade (296) at an angle to the vertical, in a portable device. Whereas, it is relatively easy to adjust the angle of the vertical plane of the blade 296 with respect to the longitudinal (x) axis of the workpiece 34.

The slide element 228 is mounted upon the base element 220 and is oriented towards the reference axis 58. The slide element 228 supports the workpiece holder 230 for slideable movement with respect to the pivot axis 58, by operation of a motor (not shown). In combination the slide element 228 and the workpiece holder 230 comprise the workpiece holding means of the present invention.

The workpiece holder 230 includes a clamping means (not shown) capable of conforming to the cross-section of the workpiece 34 for holding same during cutting operations. The clamping means could be similar to that used in the multihedral cutter 10.

The workpiece holder 230 also has a motor for pivoting of the workpiece 34 about its longitudinal axis for permitting multiple intersecting cuts to be made in the workpiece 34. The workpiece holder 230 may also have motors for adjusting and setting the x, y and z direction orientation of the workpiece 34 with respect to the pivot axis 58.

The workpiece holder 230 is typically of a cylindrical form that has a motor for adjusting the α polar direction positioning of the workpiece 34 with respect to the longitudinal axis of the cutting device 226. The workpiece holder 230 also has a throat 308 extending through its central longitudinal axis through which the workpiece 34 is inserted for cutting. The workpiece holder 230 typically has an iris type seal 309 for inhibiting the ingress of swarf from the cutting device 226 entering into the workpiece holder 230.

The controller 239 typically includes a touch screen 311 that can be programmed using a suitable machine language, a machine coded processor (such as an ARM processor or a micro-controller). Optionally the controller has a keyboard 313. The screen 311 and/or the keyboard being capable of receiving commands from an operator for conducting desired cuts in the workpiece 34.

The controller 239 may be operated via inputs from a user or may be programmed to produce industry standard cuts—such as, for example, cuts commonly used for roofing rafters in a house. Such programs may come in the form of templates that may be loaded into the controller in a manner commonly used for such programming.

Typically, the controller 239 has three command buttons corresponding to “clamp”, “cut” and “unclamp”. The workpiece holder 230 includes sensors capable of identifying the longitudinal position of the workpiece 34 with respect to the plane of the cutting blade 296. The controller 239 also has feedback means to indicate to an operator when the workpiece 34 has been placed in a position suitable for a cut to be made. The feedback could include light and/or sound—such as is used in a laser levelling system.

The controller 239 has further buttons or active screen locations for initiating “standard” cuts in the workpiece, such as, for example, “cut 45 degrees” and “cut 90 degrees”. These may also include a “custom cut” command and the like.

Typically, the motors are stepper motors electronically controlled by the controller. Each of the stepper motors typically has a gearbox or a ring gear and pinion or the like for enabling small movements between the elements they connect. Typically, the stepper motors interface with their respective controlled components via worm drives and drive gears. These motors, gears, and pinions are similar in configuration to those used in robotic arms.

### Use

In general use of the multihedral cutter 200 is somewhat similar to that of the multihedral cutter 10—except that it is automated by the controller 239.

In use, the base element 220 is set upon a surface, such as a work bench. The workpiece 34 is inserted into the workpiece holder 230, which is then adjusted to clamp onto the workpiece 34. The radial angle of the workpiece holder 230, the angle of pivot of the swivel element 222, and the angle to the vertical of the cutting head 291 are all adjusted for the orientation of the cut. The cutting device 226 is then powered up to spin the cutting blade 296 and the arm 280 driven longitudinally and pivotally for bringing the blade 296 towards the workpiece 34. Simultaneously the guards 301 are opened and the blade 296 allowed to pass into and/or through the workpiece 34.

More particularly the cutting operation is conducted as follows:
a. adjusting the workpiece stepper motor to move the workpiece in the X direction;
b. adjusting the Y and Z direction stepper motors on the workpiece holder 230 to set the transverse Y & Z positions of the workpiece;
c. adjusting the angle of the drum of the workpiece holder with the α polar motor to set the radial position of the workpiece;
d. operating the swivel element 222 stepper motor to move the cutting device 226 to the desired angle with respect to the workpiece 34 (the required mitre position);
e. operating the arm stepper motor, two worm drives and a drive gear with two pinions to move the cutting device 226 radially up/down for the best position for the cutting blade 296 to approach the workpiece 34;
f. enabling the stepper motor to drive the reciprocation element 224 for positioning the cutting blade 296 proximate the workpiece—herein referred to as the “start” position;
g. enabling the stepper motor to pivot the blade guards 301 to open access to the cutting blade 296. The optimum position for the guards 301 is whereby the closed mouth formed between the two guards 301 is at the closest point where the cut in the workpiece 34 is to be made;
h. adjusting the reciprocation element 224 stepper motors to plunge the cutting blade 296 into the workpiece 34 and, at the same time, making sure most of the blade is covered by adjusting the pivoting of the guards 301 with their stepper motor; and
i. repeating steps b onward for further cuts.

Automation of the multihedral cutter 200 involves pressing the “clamp”, “cut” and “unclamp” buttons (where an appropriate template/microcontroller based programming combination is used) or three touch screen buttons (when a touch screen is used).

Typically, the process begins with the “unclamp” command to set the cutting device 226 to the “home” position. This sets the cutting device 226 to accept a workpiece 34 and moves the cutting blade 296 out of the way so the workpiece 34 can be passed completely through the throat 308 of the workpiece holder 230.

The workpiece 34 is inserted into the throat 308 until a tone/light goes from intermittent to solid, the user stops inserting the workpiece 34 (or reverses it if inserted too far to bring it back a solid tone—much like laser levelling systems use tone based devices to indicate positions) and the workpiece holder 230 clamps onto the workpiece 34. The distance the workpiece 34 is inserted is based on the indicated shape/thickness of the workpiece 34. Optionally, a cutting solution may be selected and the insertion distance is based on that cutting solution. Both types of insertions can be approximate as the lateral position of the workpiece can be adjusted by the workpiece holder's 230 x-direction stepper motor.

The controller also is programmed with information regarding the cutting speeds and plunge rates of various material types and wall thickness.

Once the workpiece 34 is clamped, either a standard cut is made or the cutting solution is started by pressing one of the preset cut solutions.

When the cut is complete, the cutting device 226 returns to the home position (but the workpiece holder 230 is still in clamp mode), then a tone or light illuminates to indicate that the unclamp command may be executed.

Typically, for long workpieces, a holder is provided to support the rotation of a workpiece at its distal end, while keeping the longitudinal axis as stable as possible. This could be electronically linked to the controller 239.

Cutting solutions are based on simple angles that can be stored in non-volatile memory within a micro-controller and the stepper motors would be controlled to perform one or more cuts by using various algorithms or mathematical equations.

For wood, the multihedral cutter 200 could also be programmed to make dado, rabbet, lap, dovetail and tongue and groove joints by moving the workpiece holder 230 radially, laterally or transversely in concert with the other motors.

With a “special blade”, or grinding blade for metal, tube joints could be made for space frames, roll cages and the like.

Also, when specific lengths of wood are required to be cut, the total length of the workpiece 34 can be entered into the controller 239 and then the tone would sound (when inserting into the throat 308) when the workpiece 34 final cut/s are ready to be made at the distal end.

This process provides cutting automation on a small scale due to the fact that the compound cutting ability and technology has been moved from the cutting head 291 to the workpiece holder 230 and the rotation of the workpiece 34.

It is preferred that all cuts are made with the cutting head 291 in a vertical plane since accurately supporting a workpiece and rotating it for simple cuts is far easier than supporting a heavy cutting head at an acute angle.

### Concept of the Present Invention

By the cutter 10, 200 of the present invention there is provided a solution for the accurate cutting of the workpiece 34 by first recognising that there are two Euclidian coordinate systems in use at one time when a cut is to be made in the elongate workpiece 34, the two coordinate systems being for the:

workpiece holding means; and

cutting means;

where these Euclidian coordinate systems have the same origin at the time the cut/s is/are made. The origin being the intersection of the pivot axis 56, 58, the longitudinal axis of the workpiece 34 and the plane of the cutting blade 96, 296 and the orientation of these systems being independently adjustable to create the fixed reference point in space (of the present invention). Also, the workpiece holding means coordinate system can exist at any position along the length of the elongate workpiece 34.

Secondly, the accurate cutting of the workpiece 34 is achieved by creating a fixed single reference point in space at any position along the elongate workpiece 34, the reference point being encapsulated by the elongate workpiece 34 for one or more cuts by:
adjusting up to three Euclidian axes of the workpiece holding means to intersect this point in space (this defines where, in the cross section of the workpiece 34, the longitudinal axis of rotation is located); and/or
adjusting up to three Euclidian axes of the cutting means to intersect this point in space (one axis defines which side of the cutting blade 96, 296 intersects this point, while the other axis defines the typically vertical positioning of the blade 96, 296 for precision notching); and/or
Euclidian movement (translation) of the pivot axis 56, 58 along the longitudinal axis of the workpiece 34 for making precisely disposed multihedral cut sets using multiple fixed single reference points in space that are along the length of the elongate workpiece 34.

Thirdly, the accurate cutting of the workpiece 34 is achieved by making adjustments for one or more cuts (ie a cut “set”) at each fixed single reference point along the length of the elongate workpiece 34 with each required cut angle being determined by either:

a polar adjustment to the longitudinal axis of the workpiece holder 30, 230; and/or

a polar adjustment of the pivot axis 56, 58; and/or

a polar adjustment of the orientation of the cutting blade 96, 230.

The cuts in the workpiece 34 can be made by:
movement of the cutting blade 96, 296 along the cutting plane to pass through part or all of the elongate workpiece 34; the cutting plane being focussed upon the fixed single reference point in space; and/or
Euclidian movement of the origin of the workpiece 34 along the pivot axis 56, 58 for making notches; and/or
Euclidian movement of the origin of the pivot axis 56, 58 along pivot axis 56, 58, also for making notches.

### Advantages

The multihedral cutter 10, 200 of the present invention has the advantage that it is relatively small and simple in construction, is typically portable and is capable of making single, dihedral or multihedral cuts in a workpiece 34. Also, the provision of the extension slide permits those cuts to be accurately repeated in a number of workpieces 34. Further, the workpiece holder 30, 230 allows irregular shaped workpieces 34 to be conveniently and securely held in place for accurately cutting angles.

Also, by aligning one side of the cutting blade 96, 296 with the pivot axis 56, 58 of the present invention precise cut length is achievable much smaller than the width of the cutting blade 96, 296—which accuracy is typically not achievable with prior art cutters.

### Distinguishing Features

The cutter 10, 200 of the present invention allows an elongate workpiece 34 to be pivotably adjustable about its longitudinal axis. This axis represents the X axis and is floating in free space in the Y and Z directions. The pivot axis 56, 58 can be made to intersect any point (including the centre point) of the cross-section of the elongate workpiece 34 by linearly adjusting its Y and Z positions so that it intersects the origin of a fixed plane that is pivotably adjustable about its Y and Z axis and linearly adjustable along the X axis. This fixed plane represents the cutting plane of the cutting blade 96, 296. Further, the axis of pivot of the workpiece 34 is linearly adjustable in the Y and Z directions to intersect the fixed origin of the cutting plane by:
a. securing the workpiece 34 against a fence and adjusting the Y and Z positions of the table; or
b. adjusting the Y and Z positions of a pivotably adjustable workpiece holder 30, 230.

Also the workpiece 34 can be pivotably adjusted in one or more of the ?, ? and ? polar directions.

One distinguishing feature of the cutter 10, 200 of the present invention is that it allows for a cutting plane to be rotatably adjustable about the first and second axes and optionally linearly adjustable along the third axis and a workpiece holder 30, 230 that's manually or automatically linearly adjustable along the first and second axes and rotatably adjusted about the third axis.

Another distinguishing feature of the cutter 10, 200 of the present invention is that it allows pivotable adjustment of an axially extended point of the cross-section of the elongate workpiece 34, being the floating first axis, to intersect the fixed origin of a cutting plane that can also be pivotably adjusted about the second and third axes and, at the same time, the floating first axis is also linearly adjustable along the second and third axes so that it intersects the fixed origin of the cutting plane so that cuts can intersect the origin of the cutting plane and the first axis of the workpiece 34

This allows a workpiece 34 to be angularly adjusted about an axis for an alternative way of cutting angles; whether the workpiece 34 axis is adjusted to be the centre of a piece of round bar, one corner of a square piece of wood or the mid-point of a cross-section edge of a hip rafter.

In relation to cutting notches in an elongate workpiece 34 (such as a roofing rafter) the device cutter 10, 200 of the present invention could also be provided with means to indicate when the tip of the blade 96, 296 has reached the axis of the workpiece 34. An example would be to provide a semi-circle based stop bar whereby the cutting device 26, 226 hits this stop bar when the cutting blade 96, 296 reaches the axis of the workpiece 34. This stop bar could be popped up when required and left down when full cuts are required. An adjustable stop on the cutting device 26, 226 would allow for variations in blade diameter.

Also, means could be provided to reciprocate the blade 96 (or workpiece holder 30) vertically so a clean cut can be made, such as, to produce a notch in an elongate workpiece 34. This could be achieved by the provision of a simple rotary handle with a locking pin.

### MODIFICATIONS AND VARIATIONS

It will be readily apparent to persons skilled in the relevant arts that various modifications and improvements may be made to the foregoing embodiments, in addition to those already described, without departing from the basic inventive concepts of the present invention. For example, the size of the multihedral cutter 10 could be scaled up or down, in which case the graduations 120 would be greater or less than 80 mm in total length. Also, a dial could be provided for adjusting the position of the cutting blade 96 with respect to the pivot bolt 58. Further, the cutting element 26 could use a laser or other cutting means for parting the workpiece 34. Still further, a laser could be used to indicate where the cutting blade 96 shall intersect with the workpiece 34. Further, the third Euclidean axis could be along the longitudinal axis and may possibly be used if a workpiece needs to be re-inserted and finely calibrated in a longitudinal direction with a laser o detect the endpoint of the workpiece. Here, Digital Readouts (DRO) could be used or some type of audible indicator. It could also be used if some operator found an easier way to make cuts by moving the workpiece axially by a fixed amount. Still further a non-portable version of the cutter could be made.

1. A cutter for making at least one cut in a stationary elongate workpiece, the cutter including:
a base means;
a reference axis orthogonal to the base means, the reference axis being the locus of a plurality of fixed reference points;
a cutting means pivotably mounted upon the base means about a pivot axis, the cutting means having a cutting element moveable in a cutting plane to intersect the reference axis, the orientation of the cutting element with respect to the reference axis being adjustable and settable, and the reference axis being parallel to the pivot axis; and
a workpiece holding means mounted upon the base means and moveable with respect to the reference axis, the workpiece holding means releasably retaining the workpiece for securing the workpiece with respect to the base means, the workpiece holding means having a throat extending through it, the throat being shaped to allow the elongate workpiece to pass through the workpiece holding means, and the workpiece holding means also having clamp means for securing the workpiece within the throat;
wherein the workpiece holding means adjusts the orientation of the workpiece with respect to the reference axis such that a longitudinal axis within the cross-section of the elongate workpiece can intersect one of the fixed reference points on the reference axis;
wherein the workpiece holding means can pivot the workpiece about its longitudinal axis for making a plurality of cuts in the workpiece whilst the workpiece is clamped in the workpiece holding means;
wherein the one of the fixed reference points is the intersection of the reference axis and the cutting plane;
wherein the orientation of the cutting plane with respect to the fixed reference point is adjustable for making cuts in the workpiece, the cuts being at least one from a group of cut types including a plurality of intersecting cuts and a plurality of spaced apart cuts; and
wherein the workpiece holding means adjusts the orientation of the workpiece to adjust the orientation of the cuts relative to each other.

2. A cutter according to claim 1, in which the workpiece holding means is slidable transverse to the longitudinal axis of the workpiece;
wherein the workpiece holding means can move the workpiece such that the longitudinal axis of the workpiece can be moved transversely relative to the reference axis.

3. A cutter according to claim 1, in which the orientation of the cutting element with respect to the workpiece is adjustable in α direction and at least two other directions chosen from a set including: x, y, z, β and γ, where the x, y and z directions are orthogonal Euclidean directions and the α, β and γ directions are polar angular directions, and wherein the Euclidean directions and the polar directions can be associated with at least one of a group of elements including the workpiece holding means and the cutting means.

4. A cutter for making at least one cut in a stationary elongate workpiece, the cutter including:
a base means;
a reference axis orthogonal to the base means, the reference axis being the locus of a plurality of fixed reference points; and
a cutting means pivotably mounted upon the base means about a pivot axis, the cutting means having a cutting element moveable in a cutting plane to intersect the reference axis, the orientation of the cutting element with respect to the reference axis being adjustable and settable, and the reference axis being parallel to the pivot axis;
a workpiece holding means mounted upon the base means and moveable with respect to the reference axis, the workpiece holding means releasably retaining the workpiece for securing the workpiece with respect to the base means, the workpiece holding means having a throat extending through it, the throat being shaped to allow the elongate workpiece to pass through the workpiece holding means, and the workpiece holding means also having clamp means for securing the workpiece within the throat;
wherein the workpiece holding means adjusts the orientation of the workpiece with respect to the reference axis such that a longitudinal axis within the cross-section of the elongated workpiece can intersect one of the fixed reference points on the reference axis;
wherein the workpiece holding means can pivot the workpiece about its longitudinal axis for making a plurality of cuts in the workpiece whilst the workpiece is clamped in the workpiece holding means;
wherein the one of the fixed reference points is the intersection of the reference axis and the cutting plane;
wherein the orientation of the workpiece holding means and the cutting means with respect to the fixed reference point is adjustable in an α direction and at least two other directions chosen from a set including: x, y, z, β and γ, where the x, y and z directions are orthogonal Euclidean directions and the α, β and γ directions are polar angular directions;
wherein the orientation of the cutting plane with respect to the fixed reference point is adjustable for making cuts in the workpiece, the cuts being at least one from a group of cut types including a plurality of intersecting cuts and a plurality of spaced apart cuts; and
wherein the workpiece holding means adjusts the orientation of the workpiece to adjust the orientation of the cuts relative to each other is adjustable.

5. A cutter according to claim 4, in which the workpiece holding means is slidable transverse to the longitudinal axis of the workpiece;
wherein the workpiece holding means can move the workpiece such that the longitudinal axis of the workpiece can be moved transversely relative to the reference axis.

6. A cutter according to claim 4, in which the orientation of the cutting element with respect to the workpiece in the Euclidean directions and the polar directions can be associated with at least one of a group of elements including the workpiece holding means and the cutting means.

7. A cutter according to claim 1, in which the workpiece holding means and the cutting means include means capable of securing and cutting a workpiece that has a uniform and substantially constant cross-section which may be other than rectangular.

8. A cutter according to claim 7, in which the workpiece holding means clamps to conform to at least part of the cross-sectional area of the workpiece for releasably securing the workpiece.

9. A cutter according to claim 1, in which the workpiece holding means is disposable and lockable for adjusting the transverse orientation of the workpiece with respect to the longitudinal axis of the workpiece and for adjusting the angular orientation of the workpiece with respect to the longitudinal axis of the workpiece.

10. A cutter according to claim 1, in which the workpiece holding means and the cutting means include adjustment such that any longitudinal axis interior of the workpiece can be disposed to intersect with the fixed reference point.

11. A cutter according to claim 1, also including a guide means for controlling the longitudinal position of the workpiece in the workpiece holding means so that multiple workpieces can be cut consecutively at the same position along the length of the workpiece.

12. A cutter according to claim 1, also including a slide means provided upon the base means, the slide means being displaced from the reference axis, and moveable with respect to the reference axis, the slide means supporting the rest of the workpiece holding means for adjusting the orientation of the workpiece with respect to the fixed reference point.

13. A cutter according to claim 1, wherein the cutting means is chosen from a group including a drop saw, a cold cut saw and an angle grinder, each with a circular cutting blade spun upon a shaft.

14. A cutter according to claim 1, wherein the cutting means is in the form of a hand saw.

15. A cutter according to claim 1, wherein the cutting means is chosen from a group including a band saw, a laser cutter, and a water jet cutter.

16. A cutter according to claim 1, wherein the reference axis coincides with an axis of pivot of the cutting means upon the base means.

17. A cutter according to claim 1, wherein the reference axis is parallel to and displaced from an axis of pivot of the cutting means upon the base means.

18. A cutter according to claim 1, wherein the cutting means is a drop saw having a pair of guards capable of enclosing the cutting element, and motor means for retracting the guards to permit plunging of the cutting element into the workpiece;
wherein only sufficient of the cutting element is exposed to cut the workpiece whilst avoiding fouling of the guards against the workpiece.

19. A cutter according to claim 18, including further motor means for pivoting the cutting element about its axis of rotation for pivoting the guards for changing the angle that the cutting element can be plunged into the workpiece.
